(19) United States
(12) Patent Application Publication
(10) Pub. No.: US 2026/0142425 A1
(43) Pub. Date: May 21, 2026

(54) ELECTRICAL SHIELDING CONFIGURATION FOR HIGH-SPEED ELECTRICAL CONNECTOR

(71) Applicant: TE Connectivity Solutions GmbH, Schaffhausen (CH)

(72) Inventors: Randall Robert Henry, Middletown, PA (US); Brandon Michael Matthews, Middletown, PA (US); Rakesh K, Middletown, PA (US)

(21) Appl. No.: 18/955,516

(22) Filed: Nov. 21, 2024

(51) Int. Cl. H01R 13/6594; H01R 13/6596

(52) U.S. Cl. CPC H01R 13/6594; H01R 13/6596

(57) ABSTRACT

An electrical connector includes an inner housing received in a chamber of an outer housing. The inner housing has a conductive housing body extending between a mating end mated with a pluggable module and a mounting end mounted to a host circuit board. The electrical connector includes a contact assembly having contact inserts of contacts arranged in pairs and received in contact channels. The electrical connector includes a ground shield coupled to the inner housing to close the contact channels such that the ground shield and the conductive housing body provide electrical shielding for the contact inserts.

### BACKGROUND OF THE INVENTION

The subject matter herein relates generally to high speed electrical connectors.

Electrical connectors are used to connect various components of a system. For example, the electrical connectors may include a receptacle connector and a plug connector configured to be mated to the receptacle connector. In some systems, the receptacle connector includes a card slot and the plug connector includes a circuit card configured to be plugged into the card slot to mate with contacts of the receptacle connector. As data rates increase, shielding of the signal lines becomes critical to improve signal integrity, such as by reducing cross-talk between the various contacts. Gaps in shielding become problematic at high data rates. Typically, the transition or mating interfaces between the various components have inherent discontinuities, leading to signal degradation at the transitions. For example, at the transition between the receptacle connector and the host circuit board on which the receptacle connector is mounted, signal degradation occurs. Additionally, signal degradation occurs at the separable mating interface between the plug connector and the receptacle connector. Conventional electrical connectors typically use stamped and formed ground shields to provide shielding. However, such stamped and formed ground shields have limits to the shielding capability due to the shape and positioning of the ground shields relative to the contacts.

A need remains for an improved shield structure for high-speed electrical connectors.

### BRIEF DESCRIPTION OF THE INVENTION

In one embodiment, an electrical connector is provided and includes an outer housing that has a dielectric body defining a chamber. The electrical connector includes an inner housing received in the chamber. The inner housing has a conductive housing body extending between a mating end and a mounting end. The mating end configured to be mated with a pluggable module. The mounting end configured to be mounted to a host circuit board. The housing body includes contact channels. The housing body provides electrical shielding between each of the contact channels. The electrical connector includes a contact assembly coupled to the inner housing. The contact assembly includes contact inserts received in the corresponding contact channels. The contact insert includes contacts arranged in pairs received in the corresponding contact channels. Each contact includes a mating portion at the mating end configured to be mated to the pluggable module and a terminating portion at the mounting end configured to be terminated to the host circuit board. The electrical connector includes a ground shield coupled to the inner housing to close the contact channels and provide electrical shielding for the contact inserts in the contact channels. The ground shield is electrically connected to the conductive housing body. The ground shield includes mating ground beams at the mating end configured to be mated to the pluggable module. The ground shield configured to be terminated to the host circuit board.

In another embodiment, an electrical connector is provided and includes an outer housing that has a dielectric body defining a chamber. The electrical connector includes an inner housing received in the chamber. The inner housing has a conductive housing body extending between a mating end and a mounting end. The mating end configured to be mated with a pluggable module. The mounting end configured to be mounted to a host circuit board. The housing body includes connecting fingers at the mating end configured to be connected to module ground pads on a circuit card of the pluggable module. The housing body includes contact channels. The housing body provides electrical shielding between each of the contact channels. The electrical connector includes a contact assembly coupled to the inner housing. The contact assembly includes contact inserts received in the corresponding contact channels. The contact insert includes contacts arranged in pairs received in the corresponding contact channels. Each contact includes a mating portion at the mating end configured to be mated to module signal pads on the circuit card of the pluggable module. Each contact includes a terminating portion at the mounting end configured to be terminated to host signal pads on the host circuit board. The electrical connector includes a ground shield coupled to the inner housing to close the contact channels and provide electrical shielding for the contact inserts in the contact channels. The ground shield is electrically connected to the conductive housing body. The ground shield includes mating ground beams at the mating end configured to be mated to the module ground pads of the circuit card of the pluggable module. The ground shield configured to be terminated to the host circuit board.

In a further embodiment, an electrical connector is provided and includes an outer housing that has a dielectric body defining a chamber. The electrical connector includes an inner housing received in the chamber. The inner housing has a conductive housing body extending between a mating end and a mounting end. The mating end configured to be mated with a pluggable module. The mounting end configured to be mounted to a host circuit board. The housing body extending between a first side and a second side. The housing body includes first contact channels along the first side and second contact channels along the second side. The housing body provides electrical shielding between each of the first contact channels and each of the second contact channels. The electrical connector includes a contact assembly coupled to the inner housing. The contact assembly includes a plurality of contacts. Each contact includes a mating portion at the mating end configured to be mated to the pluggable module and a terminating portion at the mounting end configured to be terminated to the host circuit board. The contact assembly includes first contact inserts and second contact inserts. The first contact inserts include corresponding contacts arranged in first pairs received in the corresponding first contact channels. The second contact insert includes corresponding contacts arranged in second pairs received in the corresponding second contact channels. The inner housing defines a card slot at the mating end configured to receive a circuit card of the pluggable module. The card slot located between the first contact inserts and the second contact inserts to mate the mating ends of the corresponding contacts to both sides of the circuit card of the pluggable module.

### BRIEF DESCRIPTION OF THE DRAWINGS

FIG. 1 illustrates an electrical connector in accordance with an exemplary embodiment.

FIG. 2 is an exploded view of the contact assembly of the electrical connector in accordance with an exemplary embodiment.

FIG. 3 is a front perspective view of the conductive housing body in accordance with an exemplary embodiment.

FIG. 4 illustrates the ground shield in accordance with an exemplary embodiment.

FIG. 5 is a sectional view of a portion of the contact assembly in accordance with an exemplary embodiment.

FIG. 6 is a sectional view of a portion of the contact assembly in accordance with an exemplary embodiment.

FIG. 7 is a sectional view of a portion of the contact assembly in accordance with an exemplary embodiment showing the circuit card plugged into the card slot.

FIG. 8 is a cross-sectional view of a portion of the contact assembly in accordance with an exemplary embodiment showing the circuit card plugged into the card slot.

FIG. 9 is a bottom perspective view of a portion of the conductive housing body in accordance with an exemplary embodiment showing the mounting end of the housing body.

FIG. 10 is a top perspective view of a portion of the contact assembly showing the ground shield coupled to the conductive housing body in accordance with an exemplary embodiment.

FIG. 11 is a bottom perspective view of a portion of the contact assembly showing the ground shield partially assembled to the conductive housing body in accordance with an exemplary embodiment.

FIG. 12 is a bottom perspective view of the portion of the contact assembly showing the ground shield assembled to the conductive housing body in accordance with an exemplary embodiment.

FIG. 13 is a sectional view of the contact assembly showing the contact assembly mounted to the host circuit board in accordance with an exemplary embodiment.

FIG. 14 illustrates the electrical connector in accordance with an exemplary embodiment.

FIG. 15 illustrates the host circuit board in accordance with an exemplary embodiment.

FIG. 16 is a bottom perspective view of the electrical connector in accordance with an exemplary embodiment showing the mounting end of the electrical connector.

FIG. 17 is a sectional view of the electrical connector in accordance with an exemplary embodiment showing the circuit card plugged into the card slot of the electrical connector in accordance with an exemplary embodiment.

FIG. 18 is a sectional view of a portion of the electrical connector in accordance with an exemplary embodiment showing the circuit card plugged into the card slot of the electrical connector.

### DETAILED DESCRIPTION OF THE INVENTION

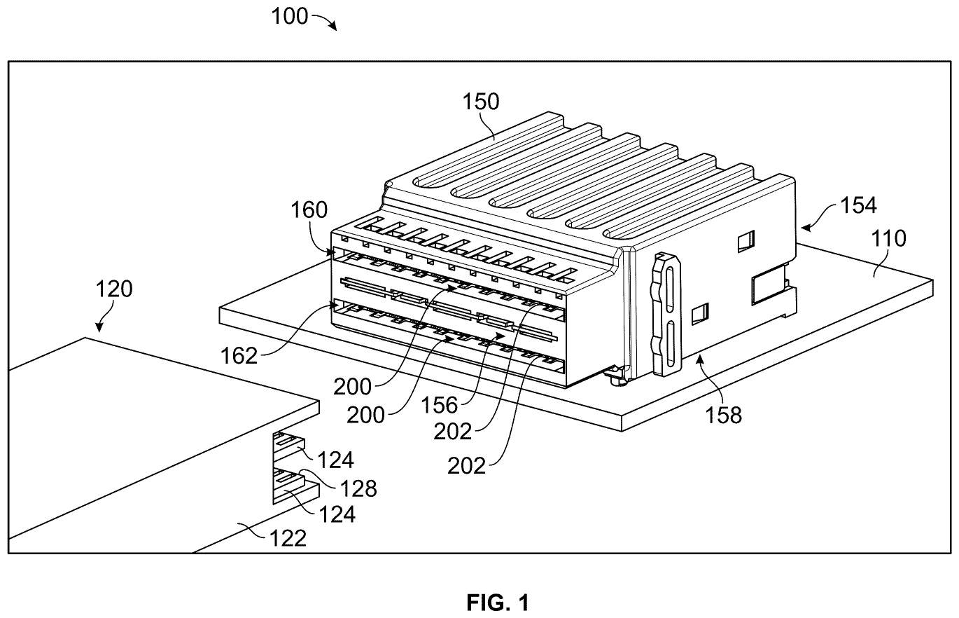

FIG. 1 illustrates an electrical connector 100 in accordance with an exemplary embodiment. The electrical connector 100 is mounted to a host circuit board 110. For example, the electrical connector 100 may be surface mounted to a surface of the host circuit board 110. A pluggable module 120 is configured to be mated to the electrical connector 100. The electrical connector 100 electrically connects the pluggable module 120 and the host circuit board 110. In an exemplary embodiment, the electrical connector 100 is a high-speed electrical connector configured to transmit high-speed electrical signals between the pluggable module 120 and the host circuit board 110.

In an exemplary embodiment, the electrical connector 100 is configured to transmit high-speed differential signals along signal lines through the electrical connector 100. In an exemplary embodiment, the electrical connector 100 includes a shielding structure configured to provide electrical shielding along the signal lines, such as along pairs of the signal lines, through the electrical connector 100 for enhanced signal integrity. For example, the electrical shielding reduces cross-talk between the pairs of signal lines. In an exemplary embodiment, the electrical connector 100 provides circumferential shielding (for example, 360° shielding) for the pairs of signal lines substantially along the entire lengths of the signal lines between the pluggable module 120 and the host circuit board 110.

In an exemplary embodiment, the electrical connector 100 and the pluggable module 120 are high-speed input/output (I/O) connectors, such as small form factor pluggable connectors (for example, SFP, QSFP, CDFP, and the like). In various embodiments, the electrical connector 100 is a receptacle connector, such as a card edge connector. For example, the electrical connector 100 includes a card slot configured to receive a circuit card of the pluggable module 120. In the illustrated embodiment, the electrical connector 100 includes a pair of the card slots configured to receive a pair of the circuit cards, which increases density and throughput of the electrical connector 100 by increasing the number of signal channels through the electrical connector 100.

The pluggable module 120 is configured to be coupled to the mating end of the electrical connector 100. In various embodiments, a cage (not shown) may surround the electrical connector 100 and the pluggable module 120 may be plugged into the cage to mate with the electrical connector 100. The pluggable module 120 includes a module housing 122 holding one or more circuit cards 124. Cables (not shown), which are electrically connected to the circuit cards 124, extend from a cable end of the module housing 122. In the illustrated embodiment, the pluggable module 120 includes a pair of the circuit cards 124 vertically stacked within the module housing 122. Each circuit card 124 has a card edge 128 configured to be plugged into the corresponding card slot of the electrical connector 100. In the illustrated embodiment, the pluggable module 120 is a PCIe plug. Other types of pluggable modules 120 may be provided in alternative embodiments. In other various embodiments, the pluggable module 120 may include the circuit card 124 without the module housing 122 and or without the cables 126. For example, this circuit card 124 may be a memory module or other type of board connector.

In an exemplary embodiment, the electrical connector 100 includes an outer housing 150 and one or more contact assemblies 200 received in the outer housing 150. The contact assembly 200 includes contacts 202 configured to be electrically connected to the pluggable module 120 and configured to be electrically connected to the host circuit board 110. In the illustrated embodiment, the electrical connector 100 includes multiple contact assemblies 200, such as an upper contact assembly and a lower contact assembly. The upper contact assembly is associated with an upper card slot 160 of the outer housing 150. The lower contact assembly is associated with a lower card slot 162 of the outer housing 150. However, in alternative embodiments, the electrical connector 100 may include a single contact assembly and a single card slot.

The outer housing 150 includes a dielectric body of 152 defining a chamber 154. The contact assembly 200 is received in the chamber 154. The outer housing 150 extends between a mating end 156 and a mounting end 158. The pluggable module 120 is configured to be mated with the outer housing 150 at the mating end 156. The outer housing 150 is configured to be mounted to the host circuit board 110 at the mounting end 158. In the illustrated embodiment, the electrical connector 100 is a right angle connector having the mating end 156 orthogonal to the mounting end 158. For example, the mating end 156 is at a front of the outer housing 150 and the mounting end 158 is at a bottom of the outer housing 150. Other orientations and configurations are possible in alternative embodiments, such as having the mating end 156 opposite the mounting end 158 (for example, at the front and rear or at the top and bottom).

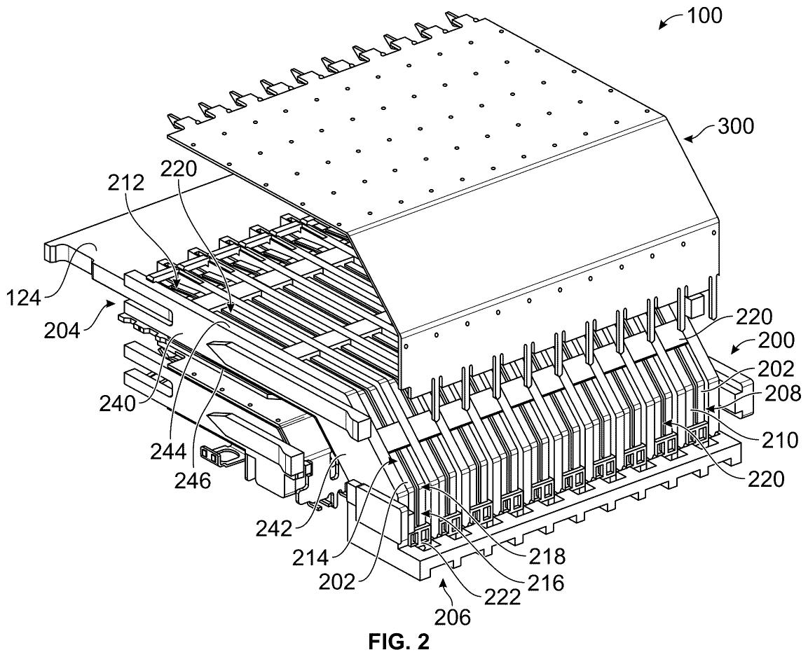

FIG. 2 is an exploded view of the contact assembly 200 of the electrical connector 100 in accordance with an exemplary embodiment. In the illustrated embodiment, the contact assembly 200 is a right-angle contact assembly having the contacts 202 extending through a right angle transition such that a mating end 204 of the contact assembly 200 is perpendicular to a mounting end 206 of the contact assembly 200. In alternative embodiments, the contacts 202 may be straight or pass through contacts where in the mating end 204 and the mounting end 206 are parallel to each other at opposite ends of the contact assembly 200. FIG. 2 illustrates the contact assembly 200 as an upper contact assembly and further illustrates a lower contact assembly below the upper contact assembly 200. Components, parts, and features of the upper contact assembly maybe similar or identical to the lower contact assembly and thus are described with reference to the upper contact assembly to avoid duplication.

The contact assembly 200 includes an inner housing 240, a contact array 208 of the contacts 202 supported by the inner housing 240, and a ground shield 300 coupled to the inner housing 240 to provide electrical shielding for the contacts 202. In an exemplary embodiment, the inner housing 240 includes a conductive housing body 242 providing electrical shielding for the contacts 202. The ground shield 300 is configured to be electrically connected to the conductive housing body 242 to form a shield structure for the contacts 202. In an exemplary embodiment, the inner housing 240 includes a first side 244 and a second side 246 opposite the first side 244. For example, the first side 244 may be an outer side and the second side 246 may be an inner side. The first side 244 may be a top side and/or a rear side. The second side 246 may be a bottom side and/or a front side. In an exemplary embodiment, the contacts 202 are arranged on both the first side 244 and the second side 246, such as to provide a high number of the contacts 202 within the contact assembly 200. In an exemplary embodiment, ground shields 300 are provided on both the first side 244 and the second side 246.

The conductive housing body 242 and the ground shield 300 cooperate to provide circumferential shielding for the contacts 202 along the length of the signal lines between the mating end 204 and the mounting end 206. For example, the conductive housing body 242 and the ground shield 300 provide 360° shielding around the corresponding contacts 202 to improve signal integrity by reducing crosstalk between the signal lines. In an exemplary embodiment, the contacts 202 are arranged in pairs (for example, differential pairs) and the shield structure defined by the conductive housing body 242 and the ground shield 300 provide 360° shielding for each pair. The conductive housing body 242 and the ground shield 300 prevent cross talk between the pairs of the contacts 202. In an exemplary embodiment, the pairs of the contacts 202 are shielded along the entire lengths between the mating end 204 and the mounting end 206.

Each contact 202 includes a contact body 210 including a transition portion 214 between a mating portion 212 and a terminating portion 216. The mating portion 212 is located at the mating end 204. The terminating portion 216 is located at the mounting end 206. In the illustrated embodiment, the transition portion 214 includes one or more bends 218 between the mating portion 212 and the terminating portion 216. For example, the bends 218 may form a 90°transition between the mating portion 212 and the terminating portion 216 such that the mating portion 212 is oriented perpendicular to the terminating portion 216. In an exemplary embodiment, the mating portion 212 includes a deflectable mating beam configured to be electrically connected to the circuit card 124. In an exemplary embodiment, the terminating portion 216 includes a solder tail configured to be soldered to a corresponding pad or circuit of the host circuit board 110. Other types of terminating portions may be provided in alternative embodiments, such as a compliant pin configured to be pressed fit into a plated via of the host circuit board 110.

In an exemplary embodiment, the contact body 210 is a stamped and formed contact stamped from a sheet of metal. In various embodiments, the contact body 210 may be manufactured from a copper material, a copper alloy material, or another type of metal. The contact body 210 may be plated or coated, such as being selectively plated. In an exemplary embodiment, the contacts 202 may be stamped from a lead frame wherein a plurality of the contacts 202 are stamped from the same sheet of metal.

In an exemplary embodiment, the contact array 208 includes a plurality of contact inserts 220 configured to be received in corresponding channels in the housing body 242. In the illustrated embodiment, each contact insert 220 includes a pair of the contacts 202. Each contact insert 220 may include greater or fewer contacts 202 in alternative embodiments.

The contact insert 220 includes one or more contact holders 222 holding the corresponding contacts 202. The contact holder 222 is configured to position the contacts 202 relative to the housing body 242. In an exemplary embodiment, the contact holder 222 is manufactured from a dielectric material, such as a plastic material, to electrically isolate the contacts 202 from the housing body 242. In an exemplary embodiment, the contact holder 222 is overmolded over the pair of the contacts 202. The contact holder 222 spans across both contacts 202 to hold the relative positions of the contacts 202. In the illustrated embodiment, the contact holder 222 is rectangular. However, the contact holder 222 may have other shapes and alternative embodiments. In the illustrated embodiment, each contact insert 220 includes multiple contact holders 222 at space locations from each other to hold the contacts 202 along the lengths of the contacts 202. For example, one or more of the contact holders 222 may hold the mating portions 212 and/or one or more of the contact holders 222 may hold the transition portions 214 and/or one or more of the contact holders 222 may hold the terminating portions 216.

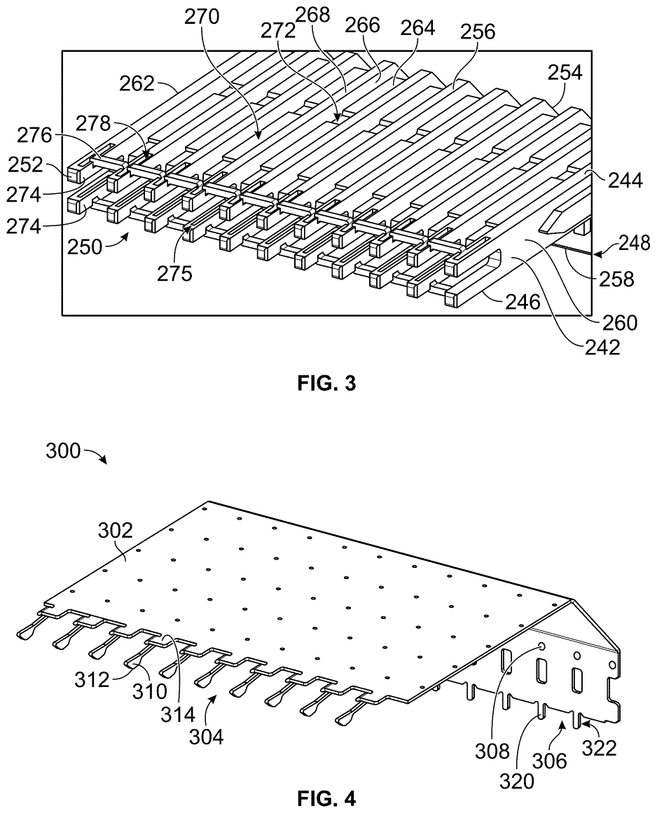

FIG. 3 is a front perspective view of the conductive housing body 242 in accordance with an exemplary embodiment. The conductive housing body 242 is electrically conductive to provide a shield structure for the contacts 202. In an exemplary embodiment, the conductive housing body 242 is a plated housing. For example, the housing body 242 may have a dielectric substrate, such as being molded from a plastic material, which is plated with an outer conductive plating layer. The plating layer may be applied by electroplating, electroless plating, physical vapor deposition (PVD) plating, spray coating, immersion coating, or other application techniques to apply the conductive layer to the substrate. In an exemplary embodiment, the entire outer surface of the housing body 242 is conductive. However, in alternative embodiments, the housing body 242 may be selectively plated and is thus conductive in selective areas. In other alternative embodiments, the housing body 242 is manufactured from a metal material, such as being die cast, machined, or otherwise manufactured from a metal material.

The housing body 242 extends between a mounting end 248 and a mating end 250. The housing body 242 includes a front 252 and a rear 254. The housing body 242 includes a top 256 and a bottom 258. The housing body 242 includes opposite ends 260, 262. In the illustrated embodiment, the mating end 250 is provided at the front 252 and the mounting end 248 is provided at the bottom 258. Other orientations are possible alternative embodiments.

In an exemplary embodiment, the housing body 242 includes a central portion 264 that extends between the mating end 250 and the mounting end 248. For example, the central portion 264 may transition between the front 252 and the bottom 258. The first and second sides 244, 246 are located on opposite sides of the central portion 264. In an exemplary embodiment, the housing body 242 includes separating ribs 266 extending from the central portion 264. The separating ribs 266 include distal or outer edges 268. In various embodiments, these separating ribs 266 are located on the first side 244 and the second side 246.

In an exemplary embodiment, the housing body 242 includes contact channels 270 at the first side 244 and/or the second side 246. The contact channels 270 are configured to receive corresponding contacts 202 (for example, pairs of the contacts 202). The conductive housing body 242 provides electrical shielding for the contact channels 270, such as along three sides of each of the contact channels 270. The conductive housing body 242 provides electrical shielding between the contact channels 270 for the corresponding pairs of the contacts 202. In an exemplary embodiment, the central portion 264 of the housing body 242 forms an end wall for each contact channel 270 and the separating ribs 266 of the housing body 242 form side walls for each of the contact channels 270. In an exemplary embodiment, the housing body 242 includes pockets 272 within the contact channels 270. The pockets 272 are configured to receive portions of the contact arrays, such as the contact holders 222.

In an exemplary embodiment, the housing body 242 includes connecting fingers 274 at the mating end 250. The connecting fingers 274 extend forward from the central portion 264. For example, the connecting fingers 274 may be cantilevered from the central portion 264 and or the separating ribs 266. The connecting fingers 274 are configured to be connected to the circuit card 124. For example, the connecting fingers 274 may be electrically connected to module ground pads on the circuit card 124. The connecting fingers 274 provide superior isolation between the pairs of signals at the mating interface. Optionally, the connecting fingers 274 may be deflectable, such as to flex outward when interfacing with the circuit card 124. In an exemplary embodiment, the housing body 242 is generally open between the connecting fingers 274, such as including openings at the top and the bottom of the connecting fingers 274. In the illustrated embodiment, the connecting fingers 274 are generally rectangular. However, the connecting fingers 274 may have other shapes and alternative embodiments.

In an exemplary embodiment, the housing body 242 includes connecting fingers 274 at both the first side 244 and the second side 246. A card slot 275 is defined between the connecting fingers 274 at the first and second sides 244, 246. The card slot 275 is configured to receive the card edge of the circuit card 124. For example, the circuit card 124 is configured to be positioned between the connecting fingers 274 at the first and second sides 244, 246. The connecting fingers 274 at the first side 244 are configured to interface with module ground pads at a first side (for example, top) of the circuit card 124 and the connecting fingers 274 at the second side 246 are configured to interface with module ground pads at a second side (for example, bottom) of the circuit card 124.

In an exemplary embodiment, the housing body 242 includes tie bars 276 extending between the connecting fingers 274. The tie bars 276 are configured to electrically connect the connecting fingers 274 at a location remote from the central portion 264, such as to reduce ground resonance along the connect fingers 274. The tie bars 276 may add rigidity or structural support to the connecting fingers 274. The tie bars 276 may be located proximate to the distal ends of the connecting fingers 274.

In an exemplary embodiment, the connecting fingers 274 include slots 278 passing therethrough. The slots 278 may be open at the top and/or the bottom of the connecting fingers 274. The slots 278 are configured to receive a portion of the ground shield 300, such as mating ground beams configured to be electrically connected to the circuit card 124.

FIG. 4 illustrates the ground shield 300 in accordance with an exemplary embodiment. In an exemplary embodiment, the ground shield 300 is a stamped and formed part. For example, the ground shield 300 may be stamped from a metal sheet and formed into a predetermined shape. The ground shield 300 is manufactured from a conductive material, such as a metal material. For example, the ground shield 300 may be manufactured from copper, aluminum, stainless steel, or other metal material.

The ground shield 300 includes one or more panels 302 extending between a mating end 304 and a terminating end 306. The panels 302 may be joined at bend lines to transition the panels 302 in different planes. In the illustrated embodiment, the ground shield 300 includes three panels 302, such as an upper panel, a rear panel, and a transition panel between the upper panel and the rear panel. The rear panel is oriented perpendicular to the upper panel and the transition panel is angled transverse to the upper and rear panels. In the illustrated embodiment, the upper panel is oriented horizontally and the rear panel is oriented vertically. Other orientations are possible in alternative embodiments.

In an exemplary embodiment, the ground shield 300 includes a plurality of bumps or embossments 308 configured to interface with the conductive housing body 242 of the inner housing 240. And alternative embodiments, the ground shield 300 may include deflectable spring beams stamped from the panels 302 configured to interface with the conductive housing body 242. The embossments 308 define points of contact the conductive housing body 242. The embossments 308 are arranged at a spacing sufficient to control resonance outside of a desired frequency.

In an exemplary embodiment, the ground shield 300 includes mating ground beams 310 at the mating end 304. Each mating ground beam 310 includes a mating interface 312 configured to interface with the circuit card 124, such as a module ground pad of the circuit card 124. The mating ground beams 310 extend from the panel 302. For example, the mating ground beams 310 extend forward from the front panel. In an exemplary embodiment, the ground shield 300 includes support tabs 314 that support the mating ground beams 310. For example, the support tabs 314 extend between the panel 302 and the mating ground beams 310. In the illustrated embodiment, the mating ground beams 310 are bent out of plane relative to the support tabs 314 and the front panel 302. For example, the mating ground beams 310 may be bent to a vertical plane whereas the support tabs 314 and the front panel 302 are on a horizontal plane. In an exemplary embodiment, the mating ground beams 310 are deflectable ground beams configured to be deflected when the mating ground beams 310 interface with the circuit card 124. The mating ground beams 310 provide a low resistance ground connection to the ground pads of the circuit card 124 in parallel to the connecting fingers 274, such as for shielding and/or to provide a low resistance ground return when power is being transmitted. In an exemplary embodiment, the made in ground beams 310 are configured to be received in these slots 278 formed in the connecting fingers 274 (shown in FIG. 3).

In an exemplary embodiment, the ground shield 300 includes terminating ground beams 320 at the mounting end 306. The terminating ground beams 320 extend from the panel 302, such as the rear panel. Each terminating ground beam 320 includes a mating interface 322 configured to interface with the host circuit board 110, such as a host ground pad of the host circuit board 110. In an exemplary embodiment, the terminating ground beams 320 are configured to be soldered to the host circuit board 110. The terminating ground beams 320 provide a low resistance ground connection to the ground pads of the host circuit board 110 in parallel to the housing body 242, such as for shielding and/or to provide a low resistance ground return when power is being transmitted.

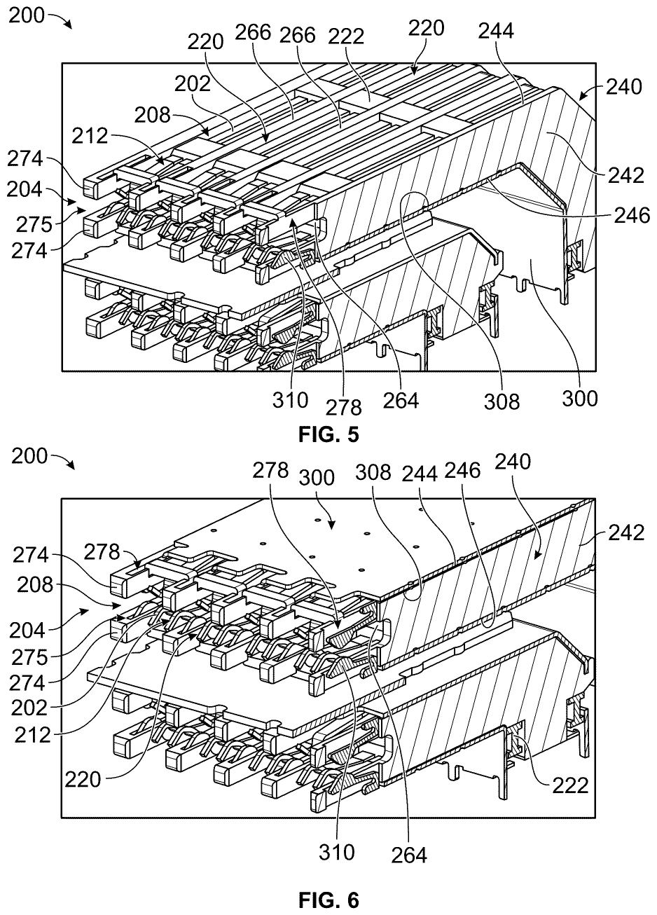

FIG. 5 is a sectional view of a portion of the contact assembly 200 in accordance with an exemplary embodiment. FIG. 6 is a sectional view of a portion of the contact assembly 200 in accordance with an exemplary embodiment. FIG. 5 shows the contact assembly 200 with one of the ground shields 300 removed to illustrate components of the contact assembly 200, whereas FIG. 6 shows the contact assembly 200 with the ground shield 300 assembled to the inner housing 240.

During assembly, the contact array 208 is inserted into the inner housing 240. For example, each contact insert 220 is inlaid into the corresponding contact channel 270 between the separating ribs 266. The separating ribs 266 are located between the pairs of the contacts 202 to provide electrical shielding between the pairs of the contacts 202. The contact holders 222 are received in the corresponding pockets 272 to position the contact inserts 220 relative to the inner housing 240. In an exemplary embodiment, the contact inserts 220 are set into the contact channels 270 on both sides 244, 246 of the housing body 242. The central portion 264 of the housing body 242 is located between the contacts 202 on opposite sides 244, 246 of the housing body 242. The central portion of 264 provides electrical shielding between the pairs of the contacts 202 on the opposite sides 244, 246 of the housing body 242. The mating portions 212 of the contacts 202 are arranged between the connecting fingers 274 at the mating end 204 of the contact assembly 200. The mating portions 212 are located in the card slot 275 to interface with the circuit card 124.

During assembly, the ground shields 300 are configured to be coupled to the inner housing 240 after the contact inserts 220 are arranged in the contact channels 270. For example, the ground shields 300 may be coupled to both sides 244, 246 of the housing body 242. The ground shields 300 are electrically connected to the conductive housing body 242, such as through the embossments 308. During assembly, the mating ground beams 310 are received in the corresponding slots 278 in the connecting fingers 274. The mating ground beams 310 are located in the card slot 275 to interface with the circuit card 124.

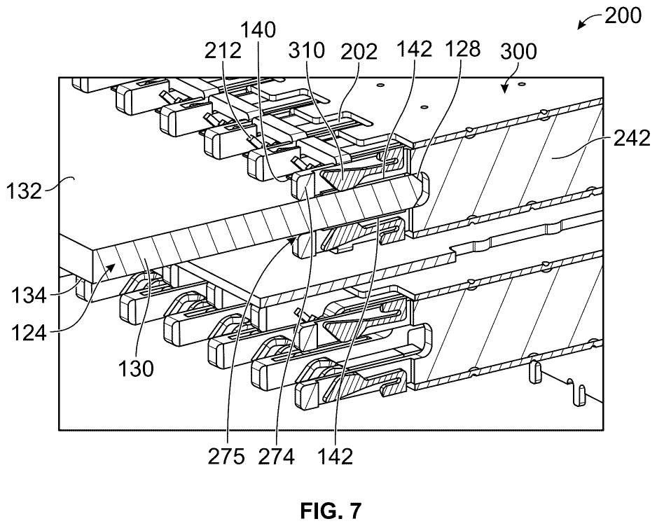

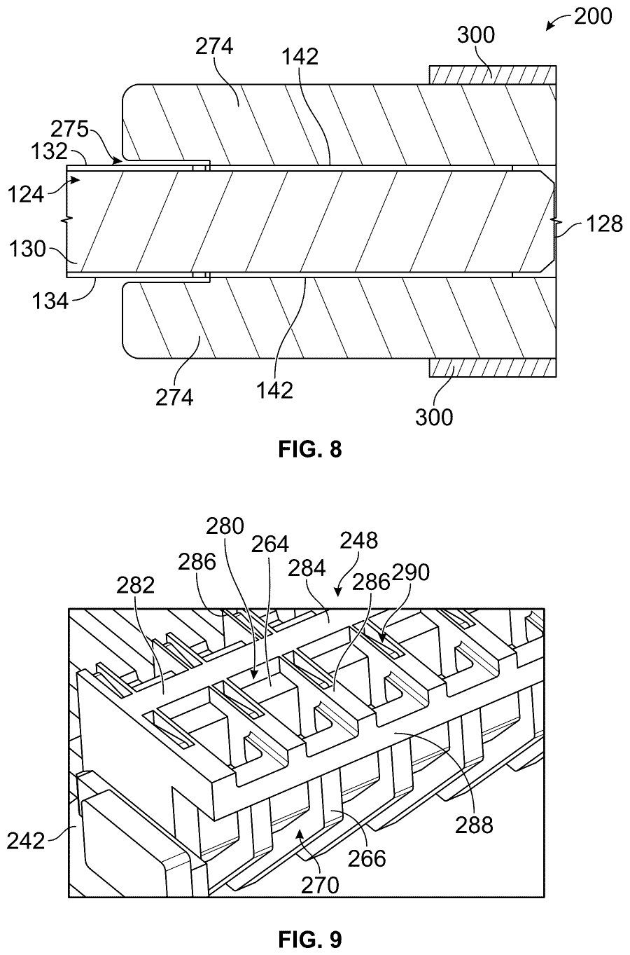

FIG. 7 is a sectional view of a portion of the contact assembly 200 in accordance with an exemplary embodiment showing the circuit card 124 plugged into the card slot 275. FIG. 8 is a cross-sectional view of a portion of the contact assembly 200 in accordance with an exemplary embodiment showing the circuit card 124 plugged into the card slot 275.

In an exemplary embodiment, the circuit card 124 includes a substrate 130 having a first surface 132 (for example upper surface) and a second surface 134 (for example, lower surface). The circuit card 124 extends to the card edge 128. The circuit card 124 includes module signal pads 140 on the surfaces 132, 134. The module signal pads 140 may be arranged in pairs. The circuit card 124 includes module ground pads 142 on the surfaces 132, 134. The module ground pads 142 may at least partially surround the pairs of the signal pads 140 to provide shielding between the pairs of the signal pads 140.

In an exemplary embodiment, the mating portions 212 of the contacts 202 are electrically connected to the module signal pads 140. For example, the mating portions 212 include deflectable spring beams configured to interface with the module signal pads 140 when the card edge 136 of the circuit card 124 is plugged into the card slot 275.

In an exemplary embodiment, the mating ground beams 310 of the ground shield 300 are electrically connected to the module ground pads 142. For example, the mating ground beams 310 include deflectable spring beams configured to interface with the module ground pads 142 when the card edge 136 of the circuit card 124 is plugged into the card slot 275.

In an exemplary embodiment, the conductive housing body 242 is configured to be electrically connected to the ground plane of the circuit card 124. For example, the connecting fingers 274 are configured to be electrically connected to the module ground pads 142. In various embodiments, the connecting fingers 274 may directly interface with the module ground pads 142 when the circuit card 124 is plugged into the card slot 275. Optionally, the connecting fingers 274 may be deflectable outward by the interference with the circuit card 124 when the circuit card 124 is plugged into the card slot 275. In alternative embodiments, rather than direct connection with the module ground pads 142, the connecting fingers 274 may be located in proximity to the module ground pads 142 to capacitively couple to the module ground pads 142.

FIG. 9 is a bottom perspective view of a portion of the conductive housing body 242 in accordance with an exemplary embodiment showing the mounting end 248 of the housing body 242. The contact channels 270 extends to the mounting end 248. For example, the central portion 264 and the separating ribs 266 extend to the mounting end 248.

In an exemplary embodiment, the housing body 242 includes pockets 280 at the mounting end 248 that receive portions of the contact inserts 220. For example, the pockets 280 are configured to receive the terminating ends of the contacts 202. In an exemplary embodiment, the housing body 242 includes connecting tabs 282 at the mounting end 248 that defined the pockets 280. The connecting tabs 282 are configured to be connected to the host circuit board 110. For example, the connecting tabs 282 are configured to be electrically connected to host ground pads of the host circuit board 110. In various embodiments, the connecting tabs 282 may be soldered to the host ground pads of the host circuit board 110.

In an exemplary embodiment, the connecting tabs 282 include a central connecting tab 284 and flanking connecting tabs 286 that extend outward from the central connecting tab 284. Optionally, the flank and connecting tabs 286 may extend from both sides of the central connecting tab 284. Each pocket 280 is defined by and surrounded on three sides by the central connecting tab 284 and the corresponding flanking connecting tabs 286. For example, the pockets 280 may be provided on both sides of the central connecting tab 284. The central connecting tab 284 generally extends along the central portion 264. The flanking connecting tabs 286 may be aligned with the separating ribs 266. For example, the flanking connecting tabs 286 may be extensions of the separating ribs 266. In various embodiments, tie bars 288 may extend between the flanking connecting tabs 286, such as at distal ends of the flanking connecting tabs 286.

In an exemplary embodiment, the connecting tabs 282 include channels 290 at the bottom of the housing body 242. The channels 290 are configured to receive portions of the ground shield 300. In the illustrated embodiment, each flanking connecting tab 286 includes a corresponding channel 290. The central connecting tab 284 may additionally include channels 290.

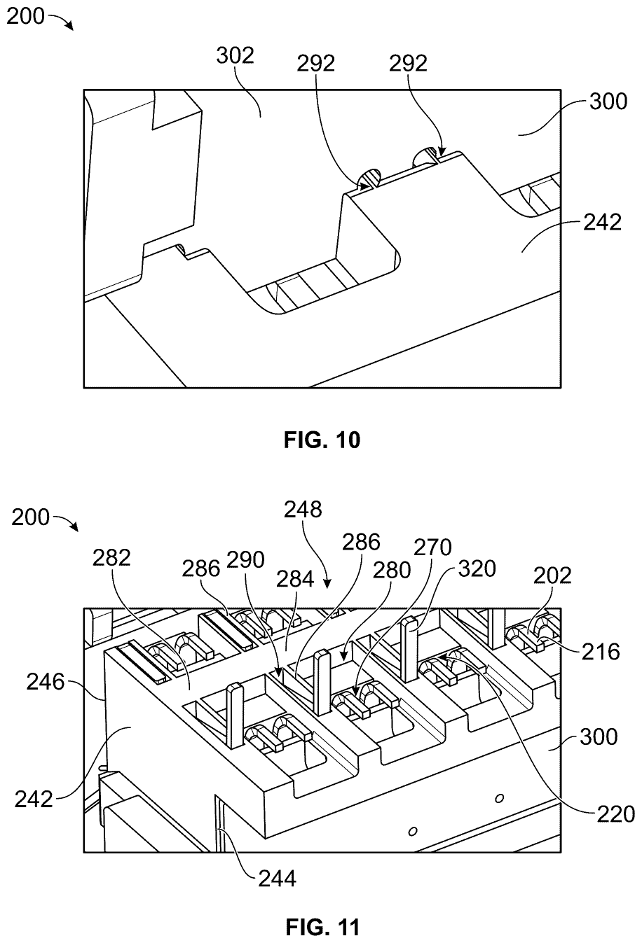

FIG. 10 is a top perspective view of a portion of the contact assembly 200 showing the ground shield 300 coupled to the conductive housing body 242. In an exemplary embodiment, the housing body 242 includes slots 292 that received the ground shield 300. The slots 292 may be open at the top to receive the ground shield 300 from above. In an exemplary embodiment, these slots 292 are tapered from the top to the bottom to receive the panel 302 of the ground shield 300 by an interference fit. The ground shield 300 is configured to be electrically connected to the Conductive housing body 242 in the slots 292 by the interference fit.

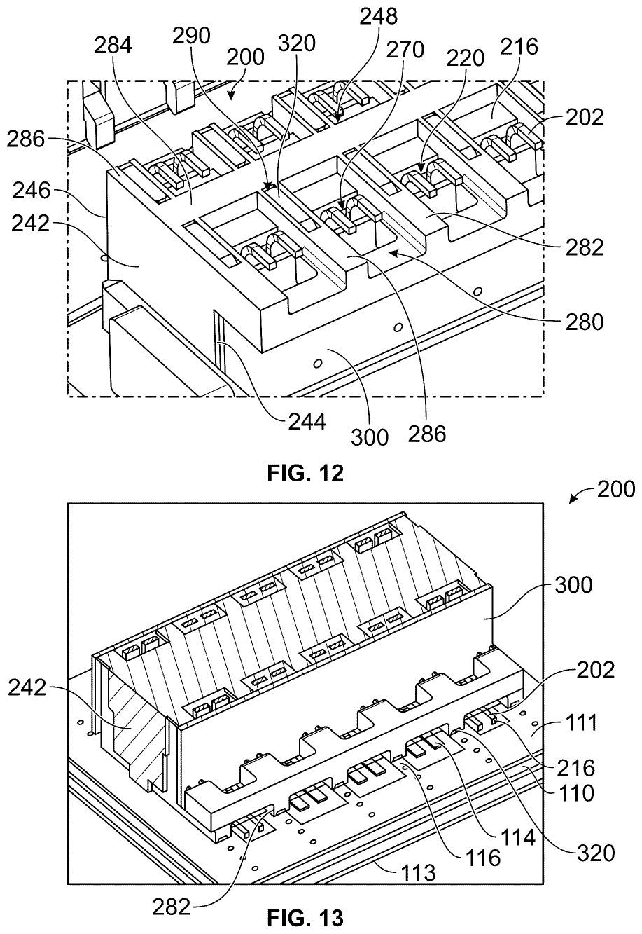

FIG. 11 is a bottom perspective view of a portion of the contact assembly 200 showing the ground shield 300 partially assembled to the conductive housing body 242. FIG. 12 is a bottom perspective view of the portion of the contact assembly 200 showing the ground shield 300 assembled to the conductive housing body 242.

During assembly, the contact inserts 220 are loaded into the corresponding contact channels 270 of the housing body 242. The terminating portions 216 extend to the mounting end 248. For example, the terminating portions 216 are received in the corresponding pockets 280 at the bottom of the housing body 242. In an exemplary embodiment, the ends of the terminating portions 216 are bent, such as 90°, to form solder tails configured to be soldered to the host circuit board 110. The connecting tabs 282 surround the pockets 280 to provide electrical shielding for the terminating portions 216 of the corresponding contacts 202. For example, the flanking connecting tabs 286 are located between the pairs of the contacts 202 to provide electrical shielding between the terminating portions 216 of the pairs of the contacts 202. The central connecting tab 284 is located between the pairs of the contacts 202 on opposite sides 244, 246 of the housing body 242. The central connecting tab 284 provides electrical shielding between the terminating portions 216 of the pairs of the contacts 202 on the opposite sides 244, 246 of the housing body 242.

During assembly, the ground shield 300 is coupled to the housing body 242. For example, the ground shield 300 may be loaded into an opening in the housing body 242 from above. The terminating ground beams 320 are configured to be loaded into the corresponding channels 290 of the housing body 242. For example, after the terminating ground beams 320 are loaded through the housing body 242, the terminating ground beams 320 may be bent into the channels 290. In an exemplary embodiment, the terminating ground beams 320 are bent to a position that is coplanar with the connecting tabs 282. As such, both the terminating ground beams 320 and the connecting tabs 282 may be surface mounted and soldered to the host circuit board 110. In an exemplary embodiment, the terminating ground beams 320 and the connecting tabs 282 are coplanar with the solder tails of the terminating portions 216 for surface mounting to the host circuit board 110.

FIG. 13 it is a sectional view of the contact assembly 200 showing the contact assembly 200 mounted to the host circuit board 110. In an exemplary embodiment, the contact assembly 200 is surface mounted to the host circuit board 110. In an exemplary embodiment, the contact assembly 200 is configured to be soldered to the host circuit board 110.

In an exemplary embodiment, the host circuit board 110 includes a substrate 112 having a first surface 111 (for example, upper surface) and a second surface 113 (for example, lower surface). The host circuit board 110 includes host signal pads 114 on at least the first surface 111. In an exemplary embodiment, the host signal pads 114 are arranged in pairs. The host circuit board 110 includes host ground pads 116 on at least the first surface 111. The host ground pads 116 may at least partially surround the pairs of the host signal pads 114 to provide shielding between the pairs of the host signal pads 114.

During assembly, the solder tails of the terminating portions 216 of the contacts 202 are configured to be soldered to the corresponding host signal pads 114. The terminating ground beams 320 and the connecting tabs 282 at the bottom of the contact assembly 200 are configured to be soldered to the corresponding host ground pads 116. As such, both the ground shield 300 and the conductive housing body 242 are electrically connected to the ground plane of the host circuit board 110. The shielding structure of the contact assembly 200 provides efficient electrical shielding for the pairs of the contacts 202. In an exemplary embodiment, the shielding structure provides circumferential shielding for the pairs of the contacts 202 through the entire contact assembly 200 from the host circuit board 110 to the pluggable module 120.

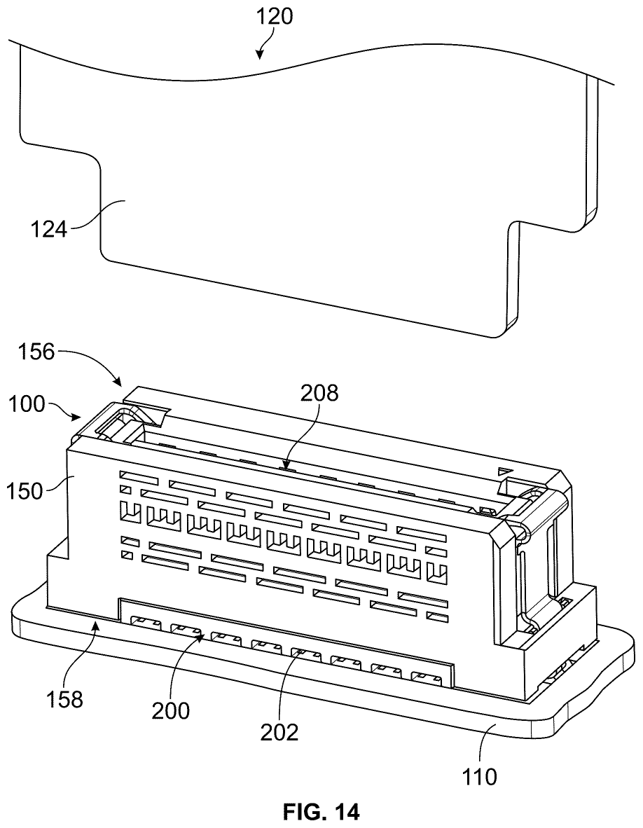

FIG. 14 illustrates the electrical connector 100 in accordance with an exemplary embodiment. In the illustrated embodiment, the electrical connector 100 is a card edge connector, such as a vertical, dual row card edge connector. The electrical connector 100 is mounted to the host circuit board 110. In the illustrated embodiment, the pluggable module 120 includes the circuit card 124, which may be an expansion card, a computer memory, or other type of card module.

In an exemplary embodiment, the electrical connector 100 includes the outer housing 150 and the contact assembly 200 received in the outer housing 150. The contact assembly 200 includes the contacts 202 arranged in the contact array 208. In the illustrated embodiment, the electrical connector 100 includes a single contact assembly 200 and a single card slot. However, in alternative embodiments, the electrical connector 100 may include multiple contact assemblies and corresponding card slots. In the illustrated embodiment, the mating end 156 and the mounting end 158 are on opposite ends of the electrical connector 100, such as at the top and the bottom, rather than being a right-angle connector.

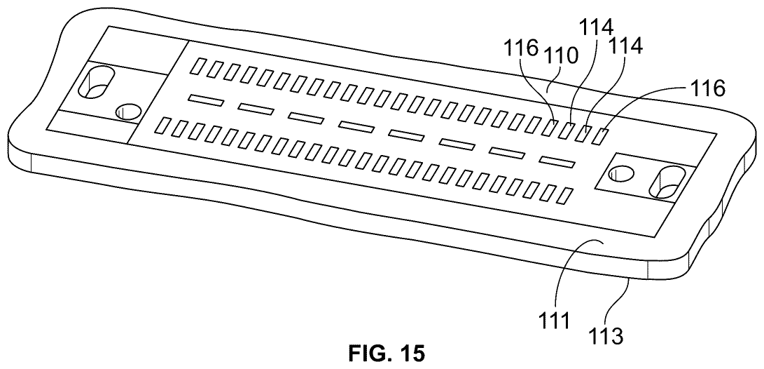

FIG. 15 illustrates the host circuit board 110 in accordance with an exemplary embodiment. The host circuit board 110 includes the substrate 112 having the first surface 111 (for example, upper surface) and the second surface 113 (for example, lower surface). The host circuit board 110 includes the host signal pads 114 on the first surface 111. In an exemplary embodiment, the host signal pads 114 are arranged in pairs. The host circuit board 110 includes the host ground pads 116 on the first surface 111. The host ground pads 116 may at least partially surround the pairs of the host signal pads 114 to provide shielding between the pairs of the host signal pads 114. For example, the host ground pads 116 are arranged between the pairs of the host signal pads 114, such as in a ground-signal-signal-ground arrangement. The host ground pads 116 may be arranged in the space between the rows of host signal pads 114.

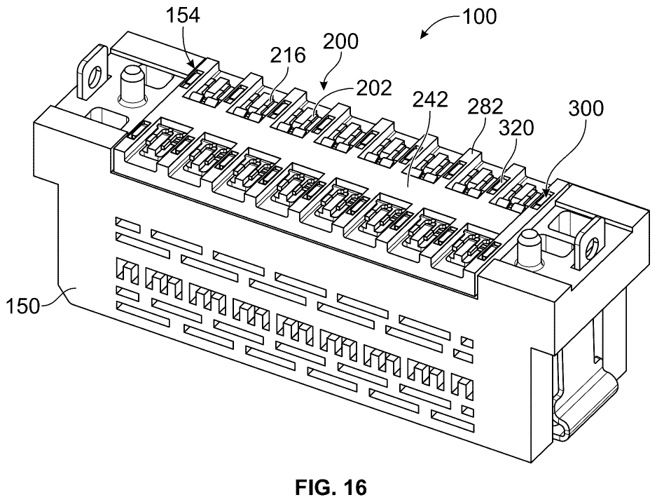

FIG. 16 is a bottom perspective view of the electrical connector 100 in accordance with an exemplary embodiment showing the mounting end of the electrical connector 100. The contact assembly 200 is arranged in the chamber 154 of the outer housing 150. The terminating portions 216 of the contacts 202 are provided at the mounting end for termination to the host circuit board 110 (FIG. 15). For example, the solder tails of the terminating portions 216 may be soldered to the host signal pads 114 of the host circuit board 110.

The terminating ground beams 320 and the connecting tabs 282 at the bottom of the contact assembly 200 are configured to be soldered to the corresponding host ground pads 116. As such, both the ground shield 300 and the conductive housing body 242 are electrically connected to the ground plane of the host circuit board 110. The shielding structure of the contact assembly 200 provides efficient electrical shielding for the pairs of the contacts 202. In an exemplary embodiment, the shielding structure provides circumferential shielding for the pairs of the contacts 202 through the entire contact assembly 200 from the host circuit board 110 to the pluggable module 120.

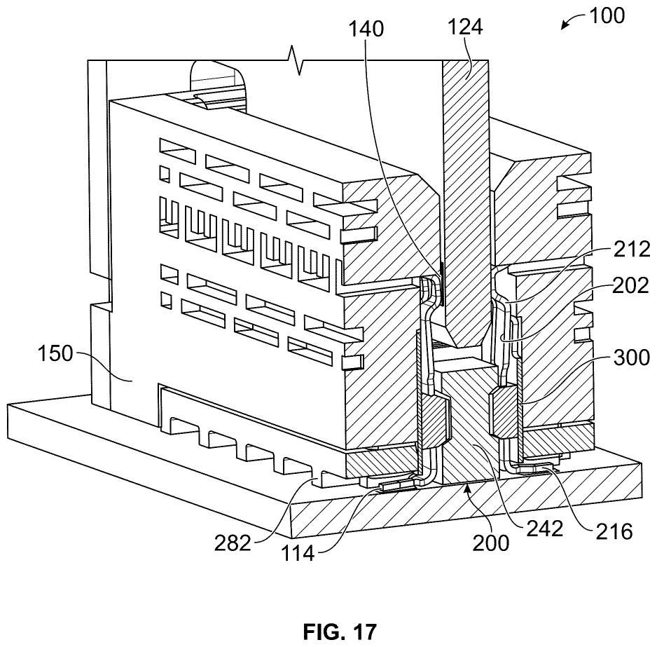

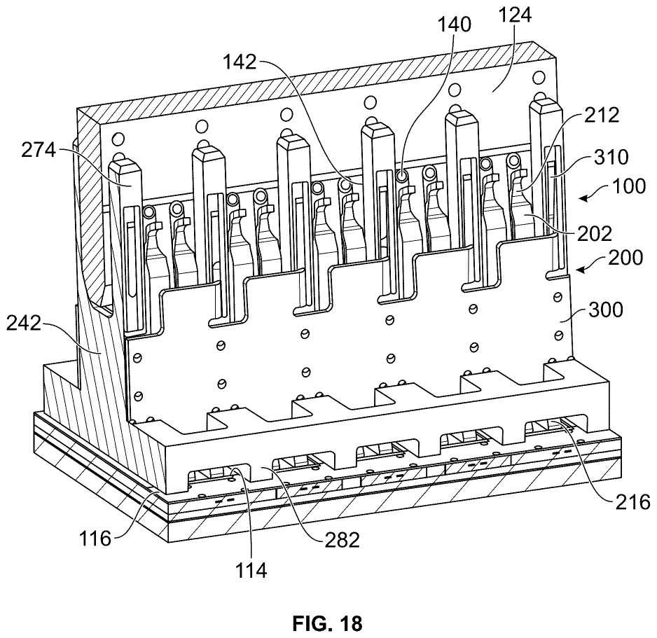

FIG. 17 is a sectional view of the electrical connector 100 in accordance with an exemplary embodiment showing the circuit card 124 plugged into the card slot of the electrical connector 100. FIG. 18 is a sectional view of a portion of the electrical connector 100 in accordance with an exemplary embodiment showing the circuit card 124 plugged into the card slot of the electrical connector 100. The outer housing 150 is removed in FIG. 18 to illustrate the internal components of the electrical connector 100. When assembled, the conductive housing body 242 and the ground shield 300 provide shielding for the signal contacts 202.

During assembly, the terminating portions 216 of the contacts 202 are terminated to the host signal pads 114 of the host circuit board 110. The terminating ground beams 320 and the connecting tabs 282 at the bottom of the contact assembly 200 are soldered to the corresponding host ground pads 116.

During mating, the circuit card 124 is plugged into the card slot to mate with the signal contacts 202. The mating portions 212 of the contacts 202 are mated to the module signal pads 140 of the circuit card 124. The connecting fingers 274 are electrically connected to the module ground pads 142. The mating ground beams 310 of the ground shield 300 are electrically connected to the module ground pads 142.

It is to be understood that the above description is intended to be illustrative, and not restrictive. For example, the above-described embodiments (and/or aspects thereof) may be used in combination with each other. In addition, many modifications may be made to adapt a particular situation or material to the teachings of the invention without departing from its scope. Dimensions, types of materials, orientations of the various components, and the number and positions of the various components described herein are intended to define parameters of certain embodiments, and are by no means limiting and are merely exemplary embodiments. Many other embodiments and modifications within the spirit and scope of the claims will be apparent to those of skill in the art upon reviewing the above description. The scope of the invention should, therefore, be determined with reference to the appended claims, along with the full scope of equivalents to which such claims are entitled. In the appended claims, the terms “including” and “in which” are used as the plain-English equivalents of the respective terms “comprising” and “wherein.” Moreover, in the following claims, the terms “first,” “second,” and “third,” etc. are used merely as labels, and are not intended to impose numerical requirements on their objects. Further, the limitations of the following claims are not written in means—plus-function format and are not intended to be interpreted based on 35 U.S.C. § 112(f), unless and until such claim limitations expressly use the phrase “means for” followed by a statement of function void of further structure.

What is claimed is:

1. An electrical connector comprising:
an outer housing having a dielectric body defining a chamber;
an inner housing received in the chamber, the inner housing having a conductive housing body extending between a mating end and a mounting end, the mating end configured to be mated with a pluggable module, the mounting end configured to be mounted to a host circuit board, the housing body including contact channels, the housing body providing electrical shielding between each of the contact channels;
a contact assembly coupled to the inner housing, the contact assembly including contact inserts received in the corresponding contact channels, the contact insert including contacts arranged in pairs received in the corresponding contact channels, each contact including a mating portion at the mating end configured to be mated to the pluggable module and a terminating portion at the mounting end configured to be terminated to the host circuit board, and
a ground shield coupled to the inner housing to close the contact channels and provide electrical shielding for the contact inserts in the contact channels, the ground shield being electrically connected to the conductive housing body, the ground shield including mating ground beams at the mating end configured to be mated to the pluggable module, the ground shield configured to be terminated to the host circuit board.

2. The electrical connector of claim 1, wherein the housing body is a plated plastic housing body having a dielectric body plated with a conductive layer.

3. The electrical connector of claim 1, wherein the conductive housing body and the ground shield provide 360° shielding for each contact insert along the length of the contact channel.

4. The electrical connector of claim 1, wherein the housing body includes connecting fingers at the mating end configured to be connected to module ground pads on a circuit card of the pluggable module.

5. The electrical connector of claim 4, wherein the connecting fingers are located between the pairs of the contacts to provide electrical shielding between the mating portions of the pairs of the contacts.

6. The electrical connector of claim 4, further comprising tie bars between the connecting fingers electrically connecting each of the connecting fingers.

7. The electrical connector of claim 4, wherein the connecting fingers includes slots, the mating ground beams being received in the corresponding slots.

8. The electrical connector of claim 4, wherein the connecting fingers include first connecting fingers and second connecting fingers on opposite sides of a card slot configured to receive a circuit card of the pluggable module.

9. The electrical connector of claim 4, wherein the connecting fingers are deflectable and configured to be flexed outward when mated to the pluggable module.

10. The electrical connector of claim 4, wherein the connecting fingers and the mating ground beams are configured to be electrically connected to ground pads on a circuit card of the pluggable module.

11. The electrical connector of claim 1, wherein the ground shield includes a panel covering a plurality of the contact channels.

12. The electrical connector of claim 11, wherein the ground shield includes embossments extending from the panel forming multiple points of contact with the conductive housing body.

13. The electrical connector of claim 1, wherein the mating ground beams are deflectable.

14. The electrical connector of claim 1, wherein each contact insert includes contact holders holding relative positions of the corresponding pair of the contacts, the contact holders received in the contact channels to isolate the contacts from the conductive housing body.

15. The electrical connector of claim 1, wherein the housing body includes a first side and a second side opposite the first side, the ground shield being a first ground shield coupled to the first side of the housing body, the electrical connector further comprising a second ground shield coupled to the second side of the housing body to close the contact channels on the second side and provide electrical shielding for the contact inserts in the contact channels on the second side, the second ground shield being electrically connected to the conductive housing body.

16. An electrical connector comprising:
an outer housing having a dielectric body defining a chamber;
an inner housing received in the chamber, the inner housing having a conductive housing body extending between a mating end and a mounting end, the mating end configured to be mated with a pluggable module, the mounting end configured to be mounted to a host circuit board, the housing body including connecting fingers at the mating end configured to be connected to module ground pads on a circuit card of the pluggable module, the housing body including contact channels, the housing body providing electrical shielding between each of the contact channels;
a contact assembly coupled to the inner housing, the contact assembly including contact inserts received in the corresponding contact channels, the contact insert including contacts arranged in pairs received in the corresponding contact channels, each contact including a mating portion at the mating end configured to be mated to module signal pads on the circuit card of the pluggable module, each contact including a terminating portion at the mounting end configured to be terminated to host signal pads on the host circuit board, and
a ground shield coupled to the inner housing to close the contact channels and provide electrical shielding for the contact inserts in the contact channels, the ground shield being electrically connected to the conductive housing body, the ground shield including mating ground beams at the mating end configured to be mated to the module ground pads of the circuit card of the pluggable module, the ground shield configured to be terminated to the host circuit board.

17. The electrical connector of claim 16, wherein the connecting fingers are located between the pairs of the contacts to provide electrical shielding between the mating portions of the pairs of the contacts.

18. The electrical connector of claim 16, further comprising tie bars between the connecting fingers electrically connecting each of the connecting fingers.

19. The electrical connector of claim 16, wherein the connecting fingers includes slots, the mating ground beams being received in the corresponding slots.

20. The electrical connector of claim 16, wherein the connecting fingers include first connecting fingers and second connecting fingers on opposite sides of a card slot configured to receive a circuit card of the pluggable module.

21. The electrical connector of claim 16, wherein the connecting fingers are deflectable and configured to be flexed outward when mated to the pluggable module.

22. The electrical connector of claim 16, wherein the connecting fingers and the mating ground beams are configured to be electrically connected to ground pads on a circuit card of the pluggable module.

23. An electrical connector comprising:
an outer housing having a dielectric body defining a chamber;
an inner housing received in the chamber, the inner housing having a conductive housing body extending between a mating end and a mounting end, the mating end configured to be mated with a pluggable module, the mounting end configured to be mounted to a host circuit board, the housing body extending between a first side and a second side, the housing body including first contact channels along the first side and second contact channels along the second side, the housing body providing electrical shielding between each of the first contact channels and each of the second contact channels;
a contact assembly coupled to the inner housing, the contact assembly including a plurality of contacts, each contact including a mating portion at the mating end configured to be mated to the pluggable module and a terminating portion at the mounting end configured to be terminated to the host circuit board, the contact assembly including first contact inserts and second contact inserts, the first contact inserts including corresponding contacts arranged in first pairs received in the corresponding first contact channels, the second contact insert including corresponding contacts arranged in second pairs received in the corresponding second contact channels;
wherein the inner housing defines a card slot at the mating end configured to receive a circuit card of the pluggable module, the card slot located between the first contact inserts and the second contact inserts to mate the mating ends of the corresponding contacts to both sides of the circuit card of the pluggable module.

24. The electrical connector of claim 19, wherein the housing body includes first connecting fingers at the first side at the mating end and second connecting fingers at the second side at the mating end, the first and second connecting fingers on opposite sides of the card slot, the first and second connecting fingers configured to be connected to module ground pads on opposite sides of the circuit card of the pluggable module.
